(19) United States
(12) Patent Application Publication
(10) Pub. No.: US 2007/0227084 A1
(43) Pub. Date: Oct. 4, 2007

(54) POLYESTER, MESH AND POLYCARBONATE HURRICANE SHUTTERS FOR WINDOWS AND DOORS

(76) Inventor: Hand Skobba, Fort Lauderdale, FL (US)

Correspondence Address: MALIN HALEY AND DIMAGGIO, PA, 1936 S ANDREWS AVENUE, FORT LAUDERDALE, FL, 33316, US

(21) Appl. No.: 11/533,576

(22) Filed: Sep. 20, 2006

Related U.S. Application Data
(63) Continuation-in-part of application No. 11/308,531, filed on Apr. 3, 2006.

(51) Int. Cl. E06B 3/26

(52) U.S. Cl. 52/202

(57) ABSTRACT

A building window and door shutter to protect against wind and wind borne foreign objects comprising a non-rigid sheet of coated waterproof polyester, a rigid polycarbonate sheet, and a second sheet of non-rigid material made of high tensile strength polyester fiber mesh that are all mounted in layers and connected by rigid tracks to a building structure adjacent the window and doors. When the shutters are not in use, the non-rigid sheets can be rolled up or folded up and stored.

This Application is a Continuation-in-Part Application Claiming the Benefit of the Filing Date of patent application Ser. No. 11/308,531 Filed Apr. 3, 2006 Entitled “Hurricane Shutters for Windows and Doors.”

### BACKGROUND OF THE INVENTION

1. Field of the Invention

The present invention relates generally to removable shutters for windows and doors for protection against wind and wind-borne debris from storm or hurricane winds and, specifically, to a shutter made from single sheets of non-rigid coated polyester material, polyester mesh material and a polycirbonate panel.

2. Description of Related Art

Extreme weather conditions, such as hurricanes, have become more frequent and more destructive. Such weather produces high velocity winds and a significant volume of precipitation. The windy conditions often pick up loose objects and turn them into airborne missiles. Windows are broken and damaged through impact by these objects when the windows are not protected. Several methods of protection have been produced, however, they are often ineffective in stopping airborne missiles, cumbersome, difficult to store, difficult to install, and not water repellant.

For example, U.S. Pat. No. 5,579,794 issued to Sporta on Dec. 3, 1996, is entitled “Apparatus and Method for Securing an Object Against Gale-force Winds”, and teaches of a protective cover that covers an entire mobile home. The Sporta patent is completely wind permeable and tied down through ground anchors. Thus, the Sporta patent is difficult to install and ineffective due to its allowance for wind penetration.

U.S. Pat. No. 5,740,639 issued to Covington on Apr. 21, 1998 is entitled “Double Panel Storm Shutter Installation with Brace” and teaches a device that has two parallel supports that receive two rigid panels above and below the rigid panels and secure them in place with screws and clams on either side of the rigid panels.

U.S. Pat. No. 6,170,050 issued to Gower on Jan. 23, 2001 is entitled “Flexible Protective Wind Abatement System” and teaches a device that attaches to the overhanging eaves of a house roof and extends to the ground below. It is then secured into the ground through stakes. It uses wind permeable mesh as the protective screen, thus allows the entry of precipitation.

U.S. Pat. No. 6,325,085 issued to Gower on Dec. 4, 2001 is entitled “Flexible Protective System to Prevent Penetration of Wind Borne Missiles” and teaches the use of flexible material that has no rigid panels for structure or stability, and is not water repellant. It simply attaches to a wall of a structure and then is secured at another end to a different surface.

U.S. Pat. No. 6,341,455 issued to Gunn on Jan. 29, 2002 is entitled “Protective Cover Assembly” and teaches a high strength fabric supported by fixed brackets, a rod and a bar. The fabric is stretched over a window through the use of a ratchet system. The fabric remains on the wall of a building when not in use.

U.S. Pat. No. 6,408,922 issued to Desrochers on Jun. 25, 2002 is entitled “Self-supporting Construction Frame and Methods of Use Thereof for the Installation of Doors and Windows” and teaches a self supporting construction frame with two vertical portions and two horizontal portions that is used in the construction of windows and door frames.

U.S. Pat. No. 6,851,464 issued to Hudoba et al. on Feb. 8, 2005 is entitled “Storm Curtain Apparatus” and teaches a storm curtain contained within a housing above a window. The curtain is rolled downward along tracks which parallel the window's sides. The curtain is secured along the bottom of the window through a bar. The curtain has strips affixed along its sides which secure it to the tracks. The strips and the curtain are two separate pieces, but various methods are used to affix them together.

U.S. Pat. No. 6,886,300 issued to Hudoba et al. on May 3, 2005 is entitled “Tensioned Fabric Storm Protection Panel” and teaches a panel that includes a frame made up of four channel members interconnected by corner members. The panel is placed in its entirety over an opening such as a window and is then removed in its entirety when not in use.

The prior art, therefore, fails to provide an impact protection device which is water repellant, highly effective, easily storable, and easily assembled and taken down.

### SUMMARY OF THE INVENTION

A window and door shutter to protect against wind and wind-borne foreign objects comprising a first flexible sheet of material made of coated waterproof polyester and a second sheet of flexible material made of high tensile strength polyester fiber in a mesh formed in side by side layer of materials, with a translucent polycarbonate panel inserted in between. When in use, the mesh sheet faces away from a window and the coated waterproof polyester sheet is closest to the window. The polycarbonate panel is inserted in a pocket created by joining the first and second flexible sheets together.

The shape and configuration of each layered cover depends on the size of each window and door to be covered. Typically, most windows and doors are rectangular. Therefore, the flexible window cover will be rectangular and slightly larger in length and width to overlap the window to be covered. The polycarbonate sheet or panel can be rectangular of smaller length and width than the first and second flexible sheets.

Each shutter for each window and door shall have a pair of rigid elongated fasteners that are firmly attached in parallel to the building on each side of the window to be covered.

Each shutter shall have rigid fastener bars mounted to the building on opposite parallel sides of the window to be covered for fastening the layered window cover (comprising both first and second flexible sheets containing the polycarbonate panel) to the building.

The side edges of the first and second sheets of material comprising the flexible layered window cover include beads that are enlarged and sized to fit into passages in order to be mounted to the window tracks on each side of the window to be covered. The translucent or clear polycarbonate panel is sandwiched between the polyester sheet and the polyester fiber mesh sheet.

Each shutter is mounted over the window and attached to the building by sliding the first and second flexible sheet side beads into the window tracks on each side from bottom to top or vice versa covering the window completely. Each track is protected by a track cover. The track cover is mounted to the building through a nut and screw mechanism. When the nut and screw mechanism is tightened, the track cover places pressure on the sheets which have been inserted into the tracks, thus preventing the first and second sheets from exiting. When the screw and nut mechanism is loosened, the pressure is released and the user may slide the sheets out of the tracks. The track cover has a stopper structure that prevents the first and second sheets from exiting the fasteners when in use.

The first and second flexible sheets of each shutter may be folded or rolled up when not in use. The polycarbonate panel is rigid and can be removed from within the pocket formed by the first and second sheets.

It is an object of this invention to provide a hurricane shutter that is strong and can protect windows and doors of buildings during a hurricane of high winds and rain while some elements of the the shutters can be rolled up for storage when not in use.

It is another object of this invention to provide window and door covers that can function as storm shutters to prevent wind and flying debris damage from breaking windows, such that the window covers are made of fabric-like materials and are lightweight and can be easily stored.

It is a further object of this invention to provide window and door covers that are lightweight and easy to install and remove by the user and are somewhat translucent to provide daylight.

It is a further object of this invention to provide a window and door cover with two separate sheets of flexible polyester materials in conjunction with a polycarbonate translucent panel.

Yet a further object of the invention is to provide a projectile barrier that is lightweight, translucent and very strong.

In accordance with these and other objects which will become apparent hereinafter, the instant invention will now be described with particular reference to the accompanying drawings.

### BRIEF DESCRIPTION OF THE DRAWINGS

FIG. 1 is a front elevational view partially cutaway of the cover with the non-rigid sheets inserted into the fasteners.

FIG. 2 is a perspective view of the cover with the polycarbonate sheet and back polyester sheet extended.

FIG. 3 is an enlarged perspective view partially cutaway of a cover fastener with the non-rigid cover sheets inserted.

FIG. 4 is a top plan view of one fastener and track cover.

FIG. 5 is an enlarged perspective view of the fastener and track cover partially cutaway and with non-rigid sheets inserted.

FIG. 6 is a perspective view of the screw and nut assembly used to secure the track cover.

FIG. 7 is a top plan view of one track cover detached from the fastener.

FIG. 8 is a front elevational view partially cutaway of a protective barrier for military use.

FIG. 9 is a top plan schematic view of the embodiment shown in FIG. 8.

FIG. 10 is a perspective view of an alternate embodiment of a shutter with mesh, polyester and a polycarbonate panel with the polycarbonate and polyester sheets extended.

### DETAILED DESCRIPTION

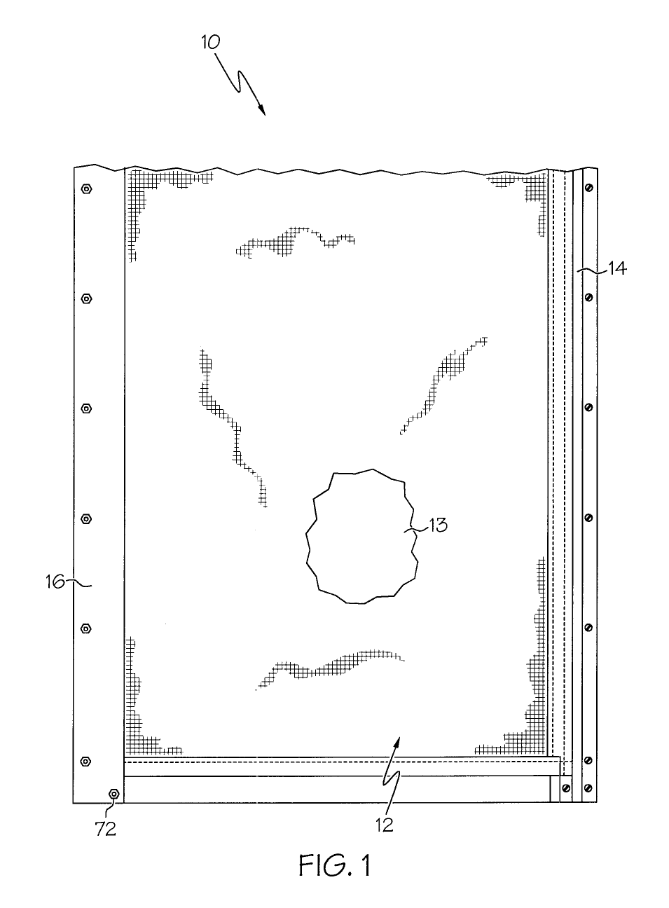

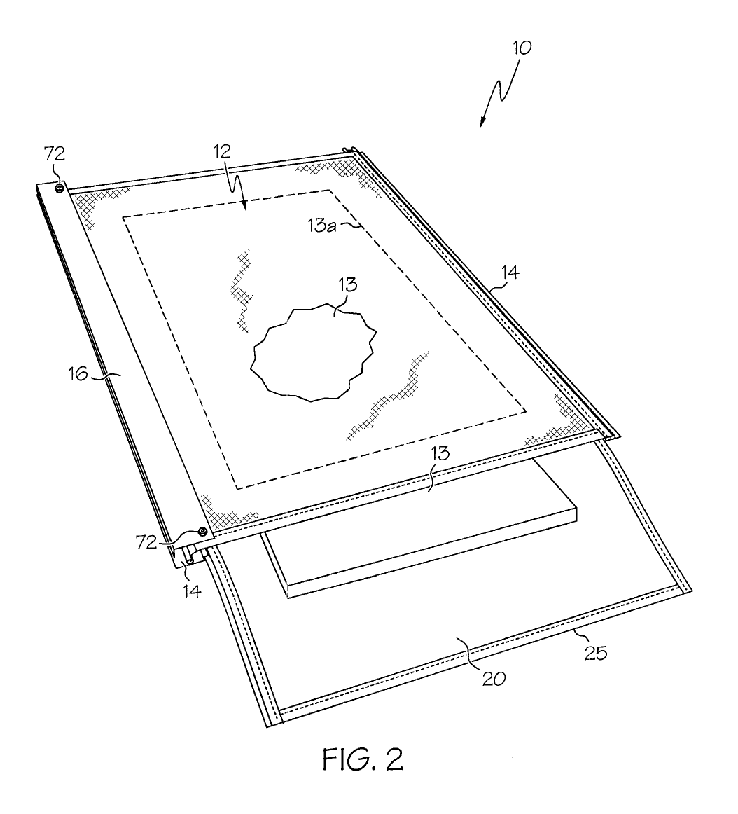

In reference to FIG. 1 and FIG. 2, the storm protective barrier 10 is shown. The protective barrier 10 is a device which protects openings, such as doors and windows, from wind, debris, external force and rain. The protective barrier 10 is shown as it would be seen in use over an opening in a building. A pair of vertical track fasteners 14 are permanently mounted to the outer surfaces of a building, house, or other structure. These fasteners 14 are to be mounted in pairs and on opposite parallel sides of the building opening. The fasteners 14 may be mounted in a vertical fashion or in a horizontal fashion. The protective barrier 10 also includes a non-rigid sheet of high tensile strength polyester mesh 12. An ideal fabric used as this mesh sheet 12 is Dacron which is commonly found as trampoline tarps on catamarans.

In the preferred embodiment, the material used for the mesh sheet 12 will be constructed of 100% polypropylene and has a ¾ basketweave construction. The material has been tested to have a tensile strength that will warp at 4632 lbs and a Mullen burst strength of 3786 psi. The typical material used to provide adequate storm protection has a tensile strength of 540 lbs and a burst strength of 825 psi. The material was tested to have a tear strength of 4533 lbs and a puncture strength of 4833 lbs. The typical material used to provide adequate storm protection has a tear strength of 200 lbs and a puncture strength of 190 lbs. The porous nature of the mesh allows air to flow through at around 230 cubic feet per minute. In addition, the material will maintain UV radiation resistance for 5000 hours. Thus, in comparing what is adequate in storm protection, to the level at which the present invention has been tested, it is clear that the present invention exceeds the necessary strength. For further comparison of necessary safety codes in storm protection, the GOWER U.S. Pat. No. 6,176,050 provides a good discussion of Mullen burst and Miami-Dade County regulations, which are the most stringent in the United States.

The mesh sheet 12 is inserted into the track fasteners 14 when used and may be taken out of the fasteners 14 when not used. FIGS. 1 and 2 further show track covers 16 which are permanently mounted to the outer surface of the building so as to cover the track fasteners 14 and protect the fasteners 14 from damage during storms. While FIG. 1 only shows one side of the protective barrier 10 as having a track cover 16, in use, there are track covers 16 over both fasteners 14 in operation. Also shown in FIG. 1 is a rectangular sheet of polycarbonate material 13 located beneath the non rigid sheet 12. This polycarbonate sheet 13 is inserted and removed as desired. The material used for this polycarbonate 13 will be lightweight, rigid, and translucent to allow sunlight. It is contemplated that a polycarbonate material known under the DuPont trademark of LEXAN may be used for the polycarbonate sheet 13, which is approximately 0.25 inches in thickness. However, the thickness of sheet 13 may vary depending upon the strength or force resistance required.

In reference to FIG. 2, a perspective view of the cover 10 is shown. The cover 10 in FIG. 2 is shown with the mesh sheet 12 installed in the track fasteners 14. The track guard 16 is installed over the left vertical fasteners 14. FIG. 2 further shows a second non rigid sheet 20 consisting of high strength, coated-waterproof polyester. When installed over a window or door, the cover 10 is mounted such that the sheet of coated polyester 20 is closer to the opening or window and the mesh sheet 12 faces outwardly from the window or opening. The polyester material most likely used for the second sheet 20 must have a weight of at least 18 oz/yd² and has been tested using a weight of 20 oz/yd² and 22 oz/yd². The second sheet 20 is coated for waterproofing and has a flame resistance quality that prevents the material 20 from being consumed within 2 minutes. It is additionally contemplated that a user may combine more than one ply of the material to create the second sheet 20 for added strength. Further, for safety purposes, the second sheet 20 may be punctured with a sharp object such that in an emergency, an occupant of a building may quickly cut an opening in the cover 10 to escape. As shown in FIG. 2, the cover 10 may be installed with both the mesh sheet 12 and the polyester sheet 20, or alternatively, the cover 10 may be installed with just one of the sheets. This is designed so that following a storm of high winds and rain, the polyester sheet 20 may be removed to allow fresh air and light to penetrate through. The sheet of polycarbonate material 13 is also shown as being inserted between the mesh sheet 12 and the polyester sheet 20. As shown with representation 13a, the shape of the polycarbonate material 13 is most probably rectangular and the size is slightly smaller than the mesh sheet 12 and the polyester sheet 20 to allow for easy insertion and removal from between the two. The both edges of sheet 12 and sheet 20 are sewn together to form a three-sided pocket to hold polycarbonate sheet 13 in place when the cover is installed. Both the mesh sheet 12 and the polyester sheet 20 may be completely removed from the fasteners 14 and rolled up for storage.

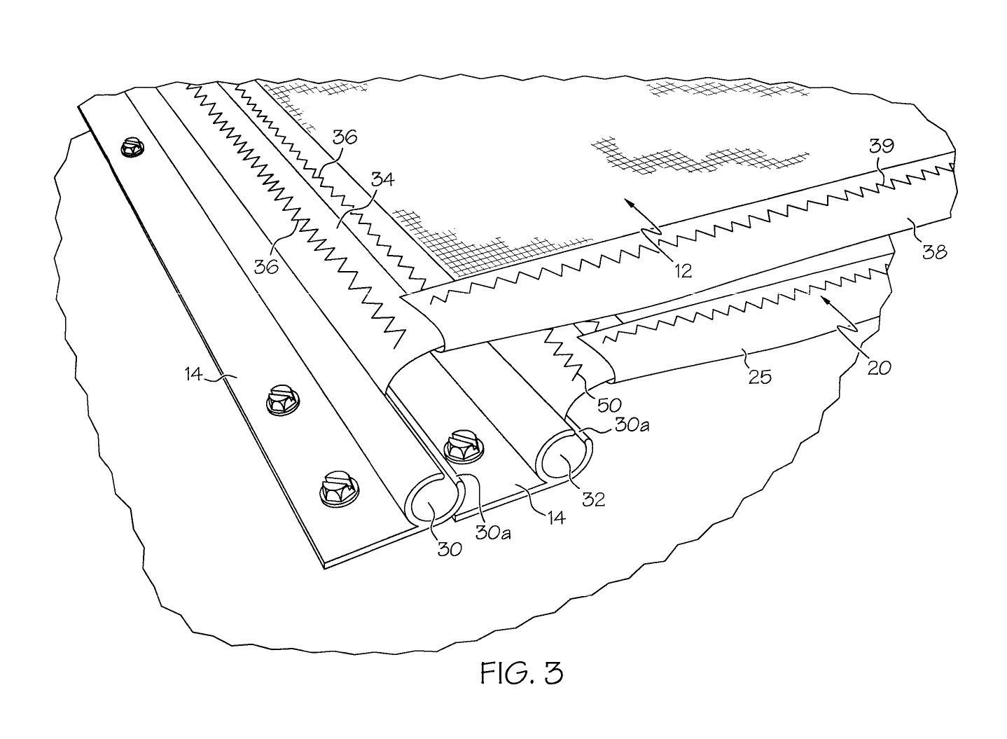

Referring now to FIG. 3, the left side vertical fasteners 14 form a pair of elongated rigid, extruded, aluminum pieces each having tubular extrusions 30 and 32 that have a channel 30a that has a slight angle towards the center of the window opening or door opening to be covered. The outer track 14 is used to anchor sheet 12 firmly to the building by sliding an enlarged bead on the sides of sheet 12 into the tube 30 securely anchoring sheet 12 along the left side of track 14. A separate track 14 on the inside has a hollow tube 32 that is used to secure the inner or body sheet of material 20 firmly to the building. Note that along the bottom edge sheet 12 and sheet 20 are sewn together so that the polycarbonate sheet 13 shown in FIG. 2 does not fall out of the bottom between the two sheets 12 and 20. The right side may include vertical tracks 14 spaced as they are shown in FIG. 3 on the left side so that sheet 12 is firmly anchored to the building by a pair of tracks 14 and sheet 20 is firmly anchored to the building by an identical pair of tracks 14 mounted inside of the track 14.

In reference to FIG. 3, an enlarged perspective view of one of the track fasteners 14 is shown. The fastener 14 is an extruded aluminum piece having a first tubular receiver 30 and a second parallel tubular receiver 32. Each tubular receiver 30, 32 has open ends, hollow cores, and an elongated longitudinal narrow open channel 30a positioned at an acute angle towards the center of the window or building opening. Many rigid materials may be used to construct the fasteners 14, however aluminum will be most common. It is shown that the tubular receivers 30, 32 do not extend completely to the edge of the fastener 14. FIG. 3 further shows both the mesh sheet 12 and the second polyester sheet 20 installed within the tubular receivers 30, 32 of the fasteners 14. As shown, the mesh sheet 12 is installed on the outer pair of tubular receivers 30 so that the mesh sheet 12 rests above the polyester sheet 20. FIG. 3 further represents the construction of the sheets 12, 20. Along the sides of the mesh sheet 12 that are inserted into the tubular receivers 30, there is a piece of high strength material 34, such as polyester. This material 34 is stitched to the mesh sheet 12 to provide strength under situations of high stress and wind. As shown, the tested and ideal method of stitching is to use one strip of category 5 zig-zag stitching and one strip of category 2 zig-zag stitching. However, it is contemplated that alternative methods of attachment are comparable. The edges of the mesh sheet 12 that are not inserted into the tubular receivers 30 also have a similar material attached to them for durability and to prevent unnecessary tears. It has been tested to use “category 2” zig-zag 39 patern on these edges. FIG. 3 also shows an enlarged view of the second polyester sheet 20. The second polyester sheet 20 is constructed of sturdy material and can be folded onto itself for secure stitching. The parallel sides of the second sheet 20 that are inserted into the tubular receivers 32 have been tested to use a zig-zag pattern of category 5 shown at 50 and category 2. Further the opposite parallel sides 25 have been tested to use a category 2 zig-zag pattern. However it is contemplated that alternative methods of attachment may be utilized.

As an alternative design, it is additionally contemplated that the fastener 14 comprise a single tubular receiver on each side of a respective opening or window. It is further contemplated that when using the single tubular receiver, the mesh sheet 12 and the second polyester sheet 20 are sewn together and are inserted into the tubular receiver with a single leader device 40, 42.

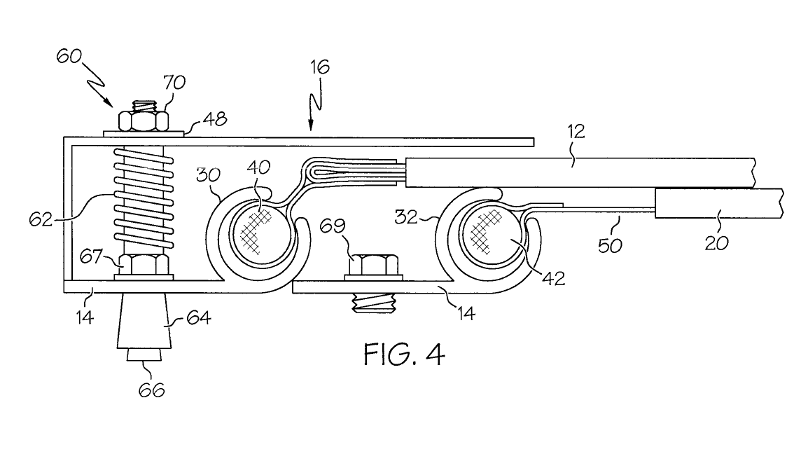

In reference to FIG. 4, a track cover 16 (an “L” shaped bar) is shown connected to the outer track fastener 14 to protect the side edges of sheets 12 and 20 during a storm are shown in the in-use mode. The outer and inner track fasteners 14 are permanently mounted to the outer surface of a building or house through the use of anchor bolts 66 and 69. FIG. 4 shows a pair of tubular receivers 30, 32 that are in each fastener 14. The tubular receivers 30, 32 and fasteners 14 are protected by the track cover 16. The track cover 16 is made of aluminum. The track cover is permanently mounted to the outer surface of a building or house through the use of a nut and screw assembly 60. This assembly 60 is such that a tubular housing 64 extends into a building and the screw 66 is able to move in and out through the rotation of a nut 70 at the top of the track cover 16 and nut 67. Each nut 70 is protected from the track cover through the use of a washer 48. For further ease of use, a spring device 62 is inserted underneath the track cover 16 such that when the nut 70 is loosened, the track cover automatically pops up. This is an important feature. The mesh sheet 12 and the second polyester sheet 20 are connected to the fastener 14 through the use of elongated leader devices 40, 42. These leader devices 40, 42 may be ropes, wires, or plastic. The leader devices 40, 42 must maintain their diameters and must have diameters large enough to not fit through the narrow elongated open channels found in each tubular receiver 30, 32. The leader device 40 which is attached to the mesh sheet 12 is contained within the stitched piece of fabric 34. The leader device 42 which is attached to the second polyester sheet 20 is contained within the polyester fabric and is simply rapped around the leader device 42. It is contemplated that the leader devices 42 can have a diameter of up to 1.5″ and are stitched into the fabric using a zig-zag pattern of between number 2 and number 6. When in use, the user simply inserts the leader devices 40, 42 into their respective tubular receiver 30, 32 and arranges it such that the sheets 12, 20 exit through the narrow open channels so as to extend to the opposite fastener 14 on the opposite side of the window or opening. Once the sheets 12, 20 are installed in the fasteners 14, the nut 70 is tightened on the screw assembly 60. This creates downward pressure on the track cover 16. The downward pressure acts as a stabilizing force on the sheets 12, 20 so they do not exit the tubular receivers 30, 32. When the user wishes to remove the sheets 12, 20 the nut 70 is simply loosened to the point at which the spring 62 pushes the track cover 16 away from them and allow for easy removal.

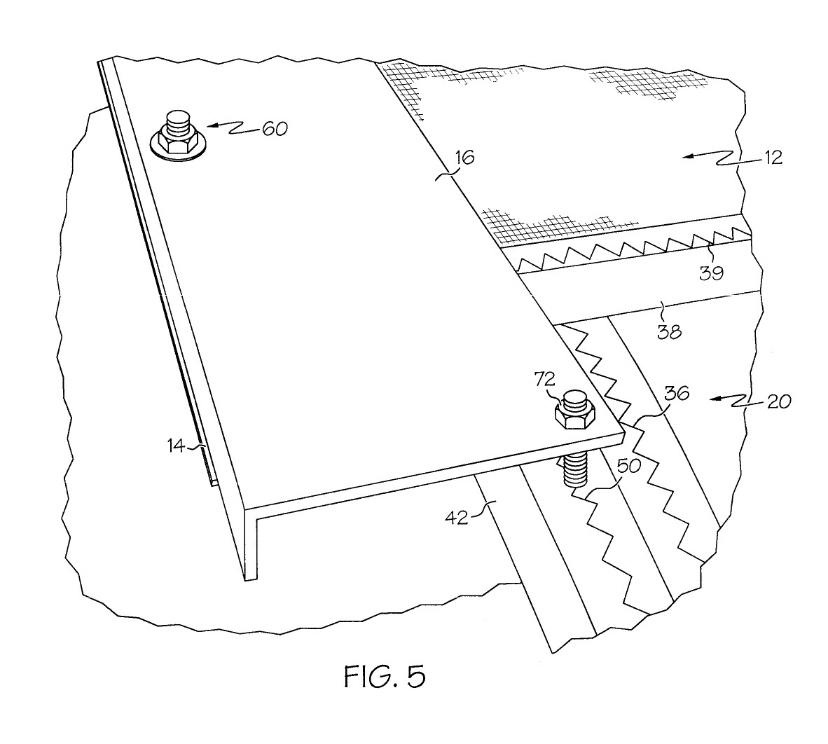

In reference to FIG. 5, an enlarged perspective view of the outer track fastener 14 and cover 16 are shown with the mesh sheet 12 inserted into the tubular receiver 30 and the elongated leader device 42 on the second polyester sheet 20 being pulled out of the tubular receiver 32. As shown, the track cover 16 extends all the way to the edge of the fastener 14. A stopper mechanism 72, located at the far ends of each track cover 16, extends through the track cover and downward toward the surface of the fastener. This stopper mechanism 72 prevents the sheets 12, 20 from exiting the tubular receivers 30, 32 unnecessarily.

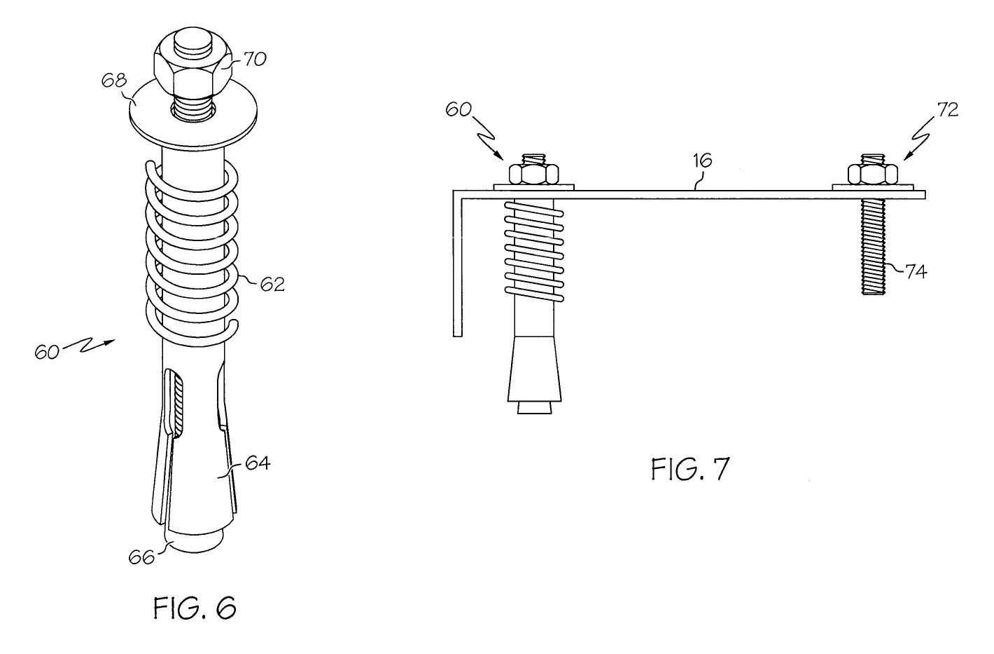

In reference to FIG. 6, an enlarged view of the screw and nut mechanism 60 is shown. Base 64 is an anchor for a concrete wall to permanently mount a track fastener 14 to a building.

In reference to FIG. 7, an enlarged front elevation view of the track cover 16 is shown removed from the track fastener 14. The track cover 16 is mounted to the fastener 14 through the use of the screw and nut assembly 60. At the far end of the overhanging portion of the track cover 16 is a stopper mechanism 72 that consists of a bottom extending screw 74. This stopper mechanism 72 does not screw into the fastener 14. The stopper mechanism 72 extends downward from the track cover 16 far enough to act as a barrier against the unwanted exit of the sheets 12, 20.

The cover 10 is mounted to a building or house to maximize structural rigidity. The fasteners 14 are not mounted to the eaves of a home or a window. Further, for aesthetic purposes, the fasteners 14 may be painted to match the color of the structure on which they are mounted.

The effectiveness of the storm and hurricane cover 10 stems from its combination of the two layers of sheets 12, 20 and a rigid polycarbonate sheet 13. When high winds accompany a storm, the wind is slowed by, but penetrates through, the mesh sheet 12. However, the polycarbonate sheet 13 and the second polyester sheet 20 are impermeable to water or wind. When the wind reaches polycarbonate sheet 13, it reverses outwardly toward the mesh sheet 12. This effect creates a pocket of air or a wind barrier between the mesh sheet 12 and the second polyester sheet 20. This pocket of air acts as a further protection device against flying debris. Thus, when the debris hits the mesh sheet 12, it is first stopped by the strength of the mesh fabric, but is secondarily stopped by the air pocket. Additionally, the non-rigid characteristic of the sheets 12, 20 allow the force absorbed to be spread outwardly and evenly. Thus, no one location on the cover 10 will be more affected by wind than another. This effect increases durability and the life of the cover 10. In addition, when the cover 10 is to be mounted onto a building in a side-by-side fashion, the displaced wind disperses in a perpetual manner to increase protection throughout.

### Alternative Embodiment

FIG. 8 is a front elevated view of the protective barrier for military use. FIG. 8 shows the protective barrier with the sheet of polyester mesh 52 having the beads 56 along either side of the mesh 52. In this embodiment, two sheets of mesh 52 are attached to each other along three edges through stitching 58. The top edges 50 of the mesh sheets 52 are left unattached. Thus, a pocket is created that is slidably inserted into the tracks mounted onto a structure. A rigid polycarbonate plate 54 is slidably inserted into the pocket in between the two mesh sheets 52. It is contemplated that the particular type of polycarbonate material 58 used will be DuPont LEXAN material because the material is lightweight, strong and translucent. It is also contemplated that the pocket may be created between two sheets of polyester 20 or a combination of polyester and polyester mesh sheets. The protective barrier shown in FIG. 8 provides protection from bullets and other projectiles. Thus, it is contemplated that the protective barrier shown in FIG. 8 can be mounted over openings in a building or vehicle to protect soldiers and/or civilians. It is further contemplated that such a protective barrier may be mounted over an opening using a fastener with a single tubular receiver on each side or a pair of tubular receivers on each side as was described above.

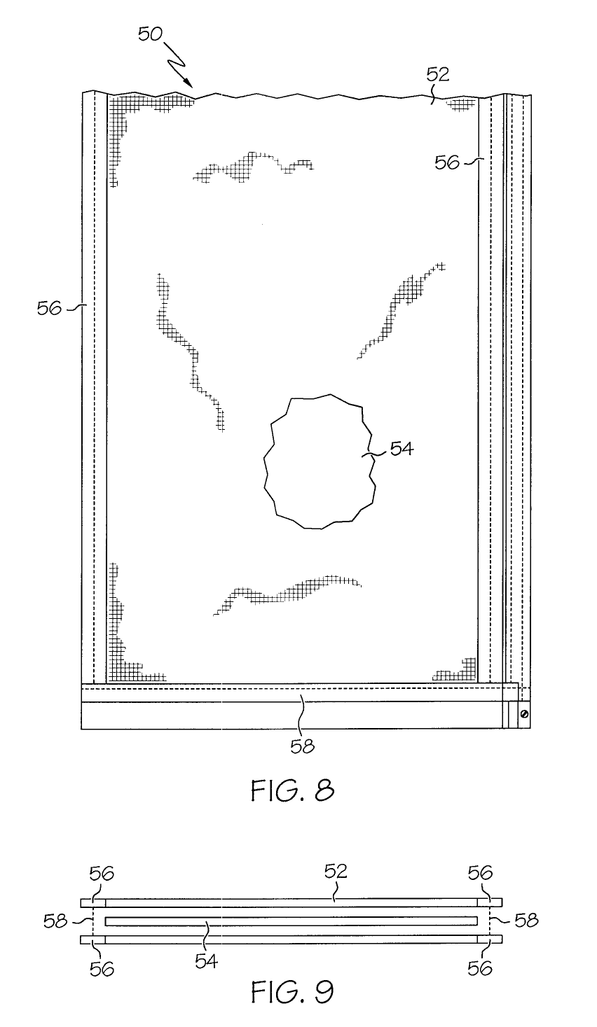

FIG. 9 is a schematic view of the embodiment shown in FIG. 8. The two mesh sheets 52 are shown with the high strength material 56 attached along either edge and the two sheets 52 stitched together 58 using a zig-zag pattern, thus creating a pocket. The polycarbonate material 54 is inserted into the pocket between the two mesh sheets 52.

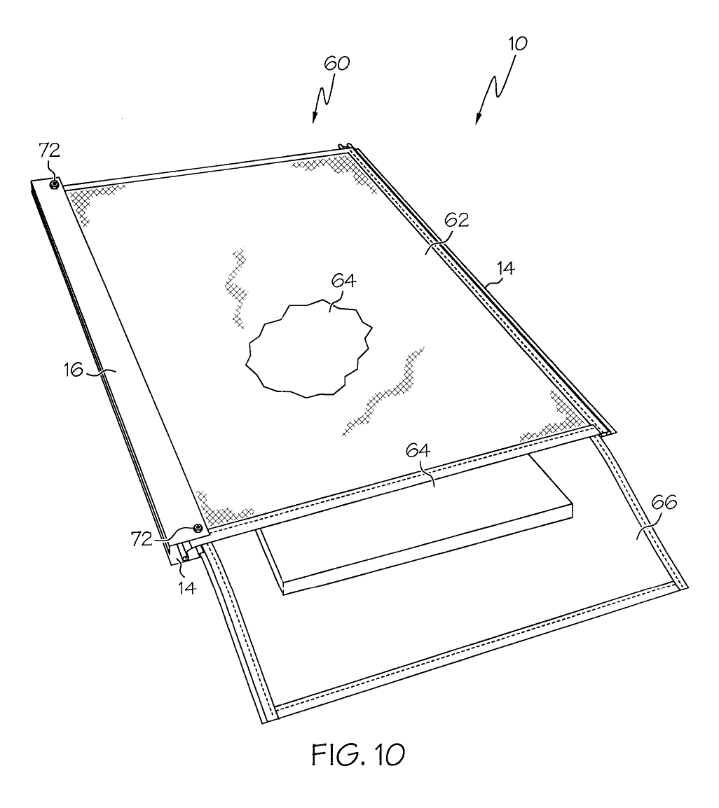

FIG. 10 is an alternative perspective view of a shutter 10 with mesh 62, polyester 66 and a polycarbonate panel 64.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A protective barrier for an opening of a structure, such as a window or door, to protect against external force and impact inducing objects comprising:
a first non-rigid sheet of synthetic material sized in length and width to overlap and exceed the opening;
a second non-rigid sheet of synthetic material sized in length and width to overlap and exceed the opening;
at least one polycarbonate panel removably inserted between the first and second non-rigid sheets of synthetic material;
a first fastener firmly attached to a first side of a window or opening on said structure and connectable to said first non-rigid sheet of synthetic material and said second sheet of synthetic material; and
a second fastener firmly attached to a second opposite side of a window or opening on said structure and connectable to said first non-rigid sheet of synthetic material and said second sheet of synthetic material.

2. The protective barrier described in claim 1, wherein the first non-rigid sheet of synthetic material is comprised of one or more ply; each ply consisting of high strength coated waterproof polyester.

3. The protective barrier described in claim 2, wherein the second non-rigid sheet of synthetic material is comprised of one or more ply of mesh; each ply consisting of high tensile strength polyester fiber mesh.

4. The protective barrier described in claim 1, wherein the first and second sheets of synthetic material are completely attached to each other along their exterior edges, but leaving the top edges unattached, thus forming a pocket capable of receiving the polycarbonate panel.

5. The protective barrier described in claim 3, wherein when in use, the first non-rigid sheet of synthetic material is closer to the window or opening in the building than the second non-rigid sheet of mesh material.

6. The protective barrier described in claim 1, wherein the first and second fasteners each have a pair of elongated tubular structures, open ends, and an elongated narrow open channel extending from one end to the other end of each fastener.

7. The protective barrier described in claim 1, wherein the first non-rigid sheet of synthetic material and the second non-rigid sheet of synthetic material further comprise elongated leader structures sewn to two opposite sides of each non-rigid sheet such that when in use, each elongated leader structure is inserted into an end of one fastener and pulled toward the other end with the non-rigid sheets inserted through the elongated narrow open channel.

8. The protective barrier described in claim 7 further comprising a pair of rigid track covers which provide protection over the entire length of each fastener.

9. The protective barrier described in claim 8, wherein the pair of rigid track covers are mounted to the structure through the use of a plurality of screw and nut assemblies and prevent the non-rigid sheets from exiting the fasteners when in use.

10. The protective barrier described in claim 9, wherein the screw and nut assemblies are spring activated such that when the screws are tightened, the track cover increases pressure on the fasteners and the non-rigid synthetic sheets and when the screws are loosened, the track cover releases pressure on the fasteners and the non-rigid sheets may easily be removed.

11. The protective barrier described in claim 10, wherein the rigid track covers further comprise a stopper structure at each end of each track cover, wherein the stopper structure prevents the non-rigid synthetic sheets from exiting the fasteners when in use.

12. A protective barrier for an opening of a structure, such as a window or door to protect against external force and impact inducing objects comprising:
a non-rigid sheet of high strength coated waterproof polyester sized in length and width to overlap and exceed the opening;
wherein the non-rigid sheet of high strength coated waterproof polyester material further comprises elongated leader structures sewn to two opposite sides of each non-rigid sheet
a first non-rigid sheet of high tensile strength polyester fiber mesh sized in length and width to overlap and exceed the opening;
wherein the non-rigid sheet of high tensile strength polyester fiber mesh further comprise elongated leader structures sewn to two opposite sides of each flexible sheet;
a second non-rigid sheet of high strength polyester mesh attached completely to the first non-rigid sheet of high strength polyester mesh along their exterior edges, but leaving the top edges unattached, thus forming a pocket capable of receiving additional sections of solid material within the two sheets of mesh;
at least one polycarbonate panel removably inserted into the pocket formed between the first and second non-rigid sheet of high strength polyester mesh;
a first pair of fasteners firmly attached to said building and connectable to said flexible sheet of coated waterproof polyester and said sheet of high tensile strength polyester fiber mesh material; and
a second pair of fasteners firmly attached to said building and connectable to said coated waterproof polyester sheet and high tensile strength polyester fiber mesh sheet;
wherein, the first and second fasteners have elongated tubular structures, open ends, and an elongated narrow channel extending from one end to the other end of each fastener.

13. The protective barrier described in claim 12, wherein when in use, each elongated leader structure is inserted into an end of one fastener and pulled toward the other end with the non-rigid sheets inserted through the elongated narrow open channel.

14. The protective barrier described in claim 12, wherein when in use, the non-rigid sheet of high strength coated waterproof polyester is closer to the window or opening in the structure than the non-rigid sheet of mesh material.

15. The protective barrier described in claim 11, wherein the polycarbonate material is translucent.

16. The protective barrier described in claim 12 further comprising a pair of rigid track covers which provide protection over the entire length of each fastener.

17. The protective barrier described in claim 16, wherein the pair of rigid track covers are mounted to the structure through the use of a plurality of screw and nut assemblies and prevent the non-rigid sheets from exiting the fasteners when in use.

18. The protective barrier described in claim 17, wherein the rigid track covers further comprise a stopper structure at each end of each track cover, wherein the stopper structure prevents the mesh sheet and the second polyester sheet from exiting the fasteners when in use.

19. The protective barrier described in claim 17, wherein the screw and nut assemblies are spring activated such that when the screws are tightened, the track cover increases pressure on the fasteners and the non-rigid sheets and when the screws are loosened, the track cover releases pressure on the fasteners and the non-rigid sheets may easily be removed.

20. A protective barrier for an opening of a structure, such as a window or door to protect against external force and impact inducing objects comprising:
a non-rigid sheet of coated waterproof polyester sized in length and width to overlap and exceed the opening;
wherein the sheet of coated waterproof polyester material further comprises elongated leader structures sewn to two opposite sides of the sheet
a first non-rigid sheet of high tensile strength polyester fiber mesh sized in length and width to overlap and exceed the opening;
wherein the non-rigid sheet of high tensile strength polyester fiber mesh further comprises elongated leader structures sewn to two opposite sides of the sheet;
a second non-rigid sheet of high strength polyester mesh attached completely to the first non-rigid sheet of high strength polyester mesh along their exterior edges, but leaving the top edges unattached, thus forming a pocket capable of receiving additional sections of solid material within the two sheets of mesh;
at least one translucent polycarbonate panel removably insertable into the pocket formed between the first and second non-rigid sheets of high strength polyster mesh;
a first fastener firmly attached to said building and connectable to said non-rigid sheet of coated waterproof polyester and said sheet of high tensile strength polyester fiber mesh material; and
a second fastener that connects with said first fastener for attaching said coated waterproof polyester sheet and high tensile strength polyester fiber mesh;
wherein, the first and second fasteners have elongated tubular structures, open ends, and an elongated narrow channel extending from one end to the other end of each fastener and when in use, each flexible elongated leader structure is inserted into an end of one fastener and pulled toward the other end with the flexible sheets inserted through the elongated narrow channel;
a pair of rigid track covers which provide protection over the entire length of each fastener;
wherein the pair of rigid track covers are mounted to the structure through the use of a plurality of screw and nut assemblies which are spring activated such that when the screws are tightened, the track cover increases pressure on the fasteners and the non-rigid sheets to prevent them from exiting the fasteners and when the screws are loosened, the track cover releases pressure on the fasteners and the non-rigid sheets may easily be removed; and
a stopper structure at each end of each track cover, wherein the stopper structure prevents the mesh sheet and the second polyester sheet from exiting the fasteners when in use.
